(19) United States
(12) Patent Application Publication
(10) Pub. No.: US 2013/0254701 A1
(43) Pub. Date: Sep. 26, 2013

(54) UNLOCKING DIGITAL CONTENT USING IMAGE RECOGNITION

(71) Applicants: Jeremy Faller, Arlingon, MA (US); Erik Walter, Woodland Hills, CA (US)

(72) Inventors: Jeremy Faller, Arlingon, MA (US); Erik Walter, Woodland Hills, CA (US)

(73) Assignee: GOOGLE INC., Mountain View, CA (US)

(21) Appl. No.: 13/425,700

(22) Filed: Mar. 21, 2012

(51) Int. Cl. G06F 3/048

(52) U.S. Cl. 715/776

(57) ABSTRACT

An electronic book system prompts a user to provide an image, for instance by taking a picture using a camera integrated on a smart phone. The user provides the image, the image is sent for processing by an image search facility and a check is made to see whether the image matches the prompt. If so, content is unlocked for access by the user. Advertising material may also be provided relating to the prompt.

### TECHNICAL FIELD

The subject matter described herein generally relates to the field of electronic media and, more particularly, to systems and methods for implementing electronic books with content that is unlocked based on image recognition.

### BACKGROUND INFORMATION

Electronic book readers, implemented on special-purpose devices as well as on conventional desktop, laptop and hand-held computers, have become commonplace. Usage of such readers has accelerated dramatically in recent years. Electronic book readers provide the convenience of having numerous books available on a single device, and also allow different devices to be used for reading in different situations. Many such devices are equipped with integrated cameras and frequent, if not persistent, connections to the Internet.

One reality of the modern world is that it is increasingly difficult to generate interest in young people to read books. Other diversions, such as video games and social networking/communications applications, provide an interactive experience that many young people find more engaging and varied than reading. It would be advantageous to extend the benefits of electronic books yet further, for instance to provide electronic books with interactive features to keep readers engaged.

A related consideration is per-user provision of content. Generally speaking, it has not been common to provide paper books on a personalized (single user) basis. However, with electronic books, it is possible to change the economies of publishing by providing works on an individualized basis. It would be advantageous to apply image recognition techniques to help enforce per-user limitations on access to content.

It would be still more advantageous to implement both of these features with the same technologies, and preferably technologies that are readily available.

### SUMMARY

An electronic book system includes: a system database storing book data and user profile information; a reader device that provides a prompt to a user to submit an image; an image processing facility configured to generate metadata corresponding to the image; and an unlocking system configured to unlock the portion of the electronic book responsive to correspondence between the prompt and the metadata. In some aspects, the portion is a chapter; in other aspects the portion relates to the image.

In further aspects, an ordering subsystem generates a communication, such as an advertisement, related to the prompt.

In still further aspects, the book also includes a prior portion, and the prior portion relates to the image.

In yet another aspect, a system includes a system database storing content and profile information of the user; an interface subsystem configured to provide a prompt to the user to supply an image; an image processing facility to receive data corresponding to the image and generate results therefrom; and an unlocking subsystem configured to unlock the content responsive to correspondence between the prompt and the results. In a related aspect, the interface subsystem also provides a subsequent prompt to the user to provide a subsequent image, the prompt and the subsequent prompt being different. In a more specific aspect, the image is a self-portrait of the user in a first pose and the subsequent image is a self-portrait of the user in a second pose.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a high-level diagram illustrating a networked environment that includes an electronic book reader.

FIG. 2 illustrates a logical view of a reader module used as part of an electronic book reader.

FIG. 3 illustrates a logical view of a system database that stores data and performs processing related to the content hosting system.

FIG. 4 illustrates one embodiment of components of an example machine able to read instructions from a machine-readable medium and execute them in a processor.

FIG. 5 illustrates one exemplary method of implementing an electronic book that includes content unlocking via image recognition.

The figures depict various embodiments for purposes of illustration only. One skilled in the art will readily recognize from the following discussion that alternative embodiments of the structures and methods illustrated herein may be employed without departing from the principles of the invention described herein.

### DETAILED DESCRIPTION

### Electronic Book System Overview

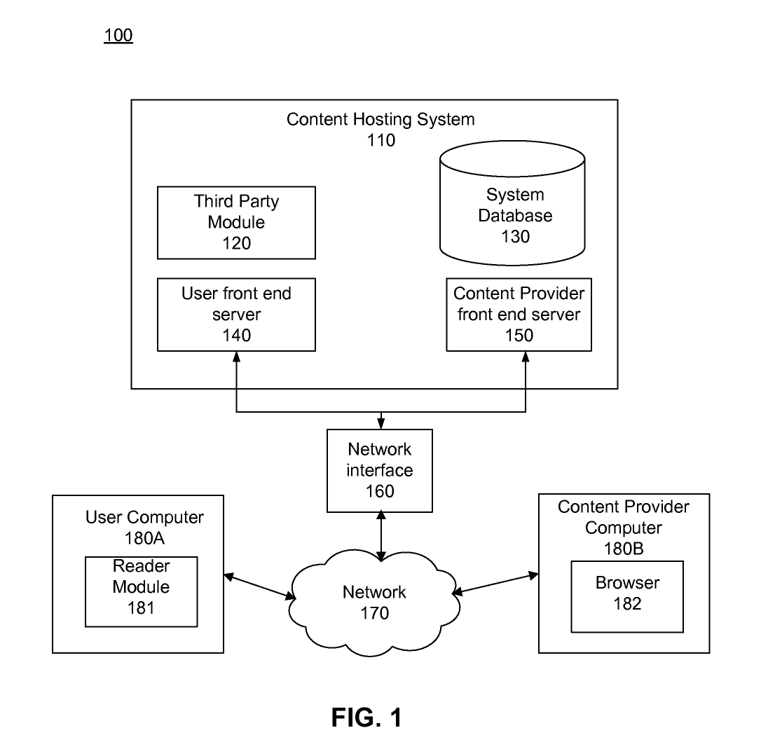

FIG. 1 is a high-level diagram illustrating a networked environment 100 that includes a content hosting system 110. The content hosting system 110 makes available for purchase, licensing, rental or subscription books that can be viewed on user and content provider computers 180 (depicted in FIG. 1, for exemplary purposes only, as individual computers 180A and 180B) using a reader module 181 or browser 182. The content hosting system 110 and computers 180 are connected by a network 170 such as a local area network or the Internet. As further detailed herein, the content hosting system 110 includes imaging capabilities such that in response to a prompt on user computer 180A, a user provides an image that, via image recognition, is determined to be an appropriate response to the prompt and that accordingly causes certain content to be unlocked. As one example to be discussed further below, a young reader of an electronic book may be prompted to take a picture of a hammer; if the reader does so, the reader is granted access to the next chapter of the book.

The network 170 is typically the Internet, but can be any network, including but not limited to any combination of a LAN, a MAN, a WAN, a mobile, a wired or wireless network, a private network, or a virtual private network. The content hosting system 110 is connected to the network 170 through a network interface 160.

Only a single user computer 180A is shown in FIG. 1, but in practice there are many (e.g., millions of) user computers 180A that can communicate with and use the content hosting system 110. Similarly, only a single content provider computer 180B is shown, but in practice there are many (e.g., thousands or even millions of) content providers 180B that can provide books and related materials for content hosting system 110. In some embodiments, reader module 181 and browser 182 include a content player (e.g., FLASH™ from Adobe Systems, Inc.), or any other player adapted for the content file formats used by the content hosting system 110.

User computer 180A with reader module 181 is used by users to purchase or otherwise obtain, and access, materials provided by the content hosting system 110. Content provider computer 180B is used by content providers (e.g., individual authors, publishing houses) to create and provide material for the content hosting system 110. A given computer can be both a client computer 180A and content provider computer 180B, depending on its usage. The hosting service 110 may differentiate between content providers and users in this instance based on which front end server is used to connect to the content hosting system 110, user logon information, or other factors.

The content hosting system 110 comprises a user front end server 140 and a content provider front end server 150 each of which can be implemented as one or more server class computers. The content provider front end server 150 is connected through the network 170 to content provider computer 180B. The content provider front end server 150 provides an interface for content providers—whether traditional book publishers or individual self-publishing authors—to create and manage materials they would like to make available to users. The user front end server 140 is connected through the network 170 to client computer 180A. The user front end server 140 provides an interface for users to access material created by content providers.

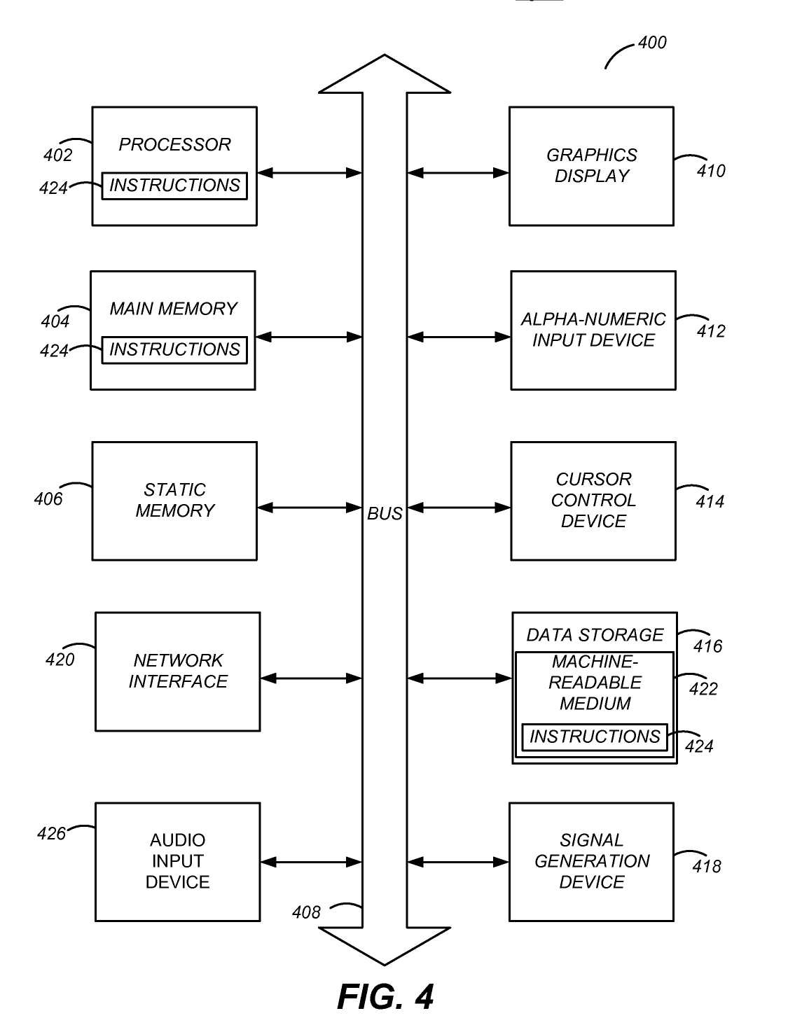

The content hosting system 110 is implemented by a network of server class computers that can include one or more high-performance CPUs and 1G or more of main memory, as well as 500 GB to 2 Tb of storage. An operating system such as LINUX is typically used. The operations of the content hosting system 110, user front end server 140 and content provider front end server 150 as described herein can be controlled through either hardware (e.g., dedicated computing devices or daughter-boards in general purpose computers), or through computer programs installed in computer storage on the servers of the system 110 and executed by the processors of such servers to perform the functions described herein. More detail regarding implementation of such machines is provided in connection with FIG. 4. One of skill in the art of system engineering and, for example, media content hosting will readily determine from the functional and algorithmic descriptions herein the construction and operation of such computer programs and hardware systems.

The content hosting system 110 further comprises a system database 130 that is communicatively coupled to the network 170. The system database 130 stores data related to the content hosting system 110 along with user and system usage information and, in some embodiments, provides related processing (e.g., the Goggles image processing functions described herein).

The system database 130 can be implemented as any device or combination of devices capable of persistently storing data in computer readable storage media, such as a hard disk drive, RAM, a writable compact disk (CD) or DVD, a solid-state memory device, or other optical/magnetic storage mediums. Other types of computer-readable storage mediums can be used, and it is expected that as new storage mediums are developed in the future, they can be configured in accordance with the descriptions set forth above.

The content hosting system 110 is further comprised of a third party module 120. The third party module 120 is implemented as part of the content hosting system 110 in conjunction with the components listed above. The third party module 120 provides a mechanism by which the system provides an open platform for additional uses relating to electronic books, much as an application programming interface allows third parties access to certain features of a software program. In some embodiments, third party input may be limited to provision of content via content provider computers 180B and content provider front end server 150. Given the wide range of possible operation of system 100, however, in some embodiments it may be desirable to open additional capabilities for third parties who are not providing content to access the system. For example, anonymous use data from groups of readers may be made available via third party module 120 to allow development of reading statistics for particular books. As a specific example, aggregated data regarding images submitted to unlock content for a particular book may be used to determine how clearly the book is prompting readers for images, and how such prompts may be improved in the future. In a typical embodiment, the user is provided with various options regarding the information collected and processed as described herein, and the user (or parents, teachers, etc. for younger users) can opt not to have certain information about the user collected or used, if the user would rather not provide such information. The image-based unlocking functions described herein are in some embodiments implemented directly via content hosting system 110 and in other embodiments implemented via third party module 120.

In this description, the term “module” refers to computational logic for providing the specified functionality. A module can be implemented in hardware, firmware, and/or software. Where the modules described herein are implemented as software, the module can be implemented as a standalone program, but can also be implemented through other means, for example as part of a larger program, as a plurality of separate programs, or as one or more statically or dynamically linked libraries. It will be understood that the named modules described herein represent one embodiment of the present invention, and other embodiments may include other modules. In addition, other embodiments may lack modules described herein and/or distribute the described functionality among the modules in a different manner. Additionally, the functionalities attributed to more than one module can be incorporated into a single module. In an embodiment where the modules as implemented by software, they are stored on a computer readable persistent storage device (e.g., hard disk), loaded into the memory, and executed by one or more processors included as part of the content hosting system 110. Alternatively, hardware or software modules may be stored elsewhere within the content hosting system 110. The content hosting system 110 includes hardware elements necessary for the operations described here, including one or more processors, high speed memory, hard disk storage and backup, network interfaces and protocols, input devices for data entry, and output devices for display, printing, or other presentations of data. FIG. 4 provides further details regarding such components.

Numerous variations from the system architecture of the illustrated content hosting system 110 are possible. The components of the system 110 and their respective functionalities can be combined or redistributed. For example, the system database 130, third party module 120, user front end server 140, and content provider front end server 150 can be distributed among any number of storage devices. The following sections describe in greater detail the reader module 181, system database 130, and the other components illustrated in FIG. 1 in greater detail, and explain their operation in the context of the content hosting system 110.

### Reader Module

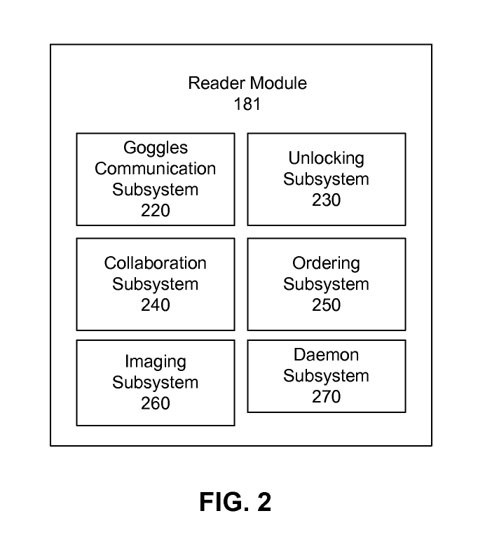

FIG. 2 illustrates a functional view of a reader module 181 used as part of a electronic book system. In the embodiment described above in connection with FIG. 1, the reader module is implemented on user computer 180A, but it should be recognized that in other embodiments, portions discussed herein could also be implemented on other computers (e.g., those in content hosting system 110) that are in communication with reader module 181.

Reader module 181 is configured, in the aspects discussed herein, to address the image-based content unlocking features detailed below. As described below, some of these features are interactive and may involve connections to map applications, provision of image-related advertisements, and the like. The image-based unlocking features discussed below are social and collaborative as well. Image-based unlocking activity in some embodiments involves not only attention to the specific book, but creation of discussion notes and reference to other related sources that may pertain to prompted images.

Reader module 181 includes various subsystems to facilitate these specialized uses. In the embodiment illustrated in FIG. 2, reader module 181 includes a Goggles communication subsystem 220, an unlocking subsystem 230, a collaboration subsystem 240, an ordering subsystem 250, an imaging subsystem 260, and a daemon subsystem 270. Many of these subsystems interact with one another, as described below.

Goggles communication subsystem 220 provides an interface with an external visual search application; in one embodiment this is implemented using the Google Goggles™ facility as described herein. For example, as described below an image obtained by imaging subsystem 260 of reader module 181 is sent to a central image processing facility via Goggles communication subsystem 220 as part of processing to determine whether a reader has correctly provided an image to unlock content for reading. Imaging subsystem 260 refers to a camera or other imaging or sensing device associated with a user's computer, for instance a digital camera integrated with a smart phone device, as well as associated processing subsystems. In some embodiments, imaging subsystem 260 includes some image recognition capabilities, the output of which is transmitted for processing via Goggles communication subsystem 220; in others a raw image is sent for centralized image recognition and other processing via Goggles communication subsystem 220.

Unlocking subsystem 230 compares image metadata retrieved from Goggles communication subsystem 220 with prompt information provided by an electronic book (e.g., from system database 130) to determine whether a match exists that permits unlocking of content. For example, an electronic children's book may prompt a reader to “get a hammer” in order to gain access to the next chapter of the book (which may be about the Norse hammer-wielding god Thor, the comic book super hero of the same name, or about how houses are built). Imaging subsystem 260 of reader module 181 communicates with Goggles communication subsystem 220 to obtain information about an image captured by the reader (i.e., a picture taken by a reader using the reader's smart phone). Continuing with the above example, if the user takes a picture of a hammer, a .jpg file of that picture is created by imaging subsystem 260 and sent for processing via Goggles communication subsystem 220, which returns metadata regarding the picture such as identifying the subject matter of the picture as a hammer. Unlocking subsystem 230 then compares the returned metadata with what was sought to determine whether they match. Conventional search-based techniques for grouping conceptually similar items are used in some embodiments, for instance so that if the information returned from Goggles communication subsystem indicates “mallet”, unlocking subsystem 230 recognizes the conceptual similarity between the prompt term (hammer) and the returned term (mallet). In some embodiments, these functions of unlocking subsystem 230 are performed on the reader module 181, while in others they are performed remotely (e.g., at the same central facility that performs the Goggles visual search processing).

While the discussion here has focused on imaging (i.e., optical sensing), other types of sensing can be applied as well. As a specific example, one type of recognition that may be helpful in a book about music theory is recognition of a sound (e.g., a specific chord as may be played on a guitar) and matching that chord to unlock further content of the book. In addition to still images and music, other sounds, video and various other types of sensed inputs are usable as well in various embodiments. As an illustrative example, a book about sounds animals make may require a user to provide the actual sound of a certain animal (e.g., a bullfrog) before unlocking related content. Users could achieve this either by actually finding a bullfrog, or by finding a recording of a bullfrog, e.g., on the Internet. In either event, the author's goal of having the reader actually hear the sound of a bullfrog is achieved. As additional technologies are integrated into user computers 180A, other types of sensing may also be available for use to unlock content as described herein (e.g., temperature, barometric pressure, relative humidity, smell or presence of certain chemicals in the air proximate to the device).

Collaboration subsystem 240 provides various user functions that allow readers to work with others. For example, students can share their comments about finding prompted items with their classmates. In some embodiments, collaboration subsystem 240 includes social network facilities to permit readers to communicate with one another with audio and visual chat, to ask and answer questions, and to submit questions to a teacher.

Ordering subsystem 250 represents tools that allow readers to obtain electronic books and related materials. In one embodiment, ordering subsystem 250 is implemented as an electronic marketplace (e.g., the ANDROID™ market implemented on the ANDROID™ operating system for smart phones and tablet computers). Third parties offer electronic books and related materials such as character guides, updates, workbooks, and the like. Some of these materials are available for purchase; others are free. In some embodiments, provision via other mechanisms (e.g., subscription, barter, “pay-per-view”) is supported, as may be desired by any subset of a reader community or content provider group. In one embodiment, ordering subsystem 250 also provides advertisements and other information relating to the images that cause content to be unlocked. For example, if a user takes a picture of a hammer, ordering subsystem 250 is in one embodiment configured to provide the user with an electronic coupon to allow the user to order a new hammer (or various types of nails) at a discount, either directly through ordering subsystem 250 or at a physical store.

Reader module also includes user interface tools to facilitate use of electronic books and related features as described herein, such as switching between reading a book and ordering a related product. Reader module 181 is further configured to permit user-selected applications to run to enhance a reader's ability to work with an electronic book. For instance, a reader may purchase an application that provides a chapter synopsis of the book so that if the reader has not picked up the book for some time, the reader can be reminded of the content that has already been read. In addition, reader module 181 includes a daemon subsystem 270 to provide additional add-on features without the reader launching a visible application for such features. As one example, a reader of a book about music may have one or more daemons that allow recognition of images of sheet music and audio playback of the corresponding music, or that recognize particular melodies that may be captured by a microphone associated with user computer 180A, or that synthesize musical compositions based on a reader's input.

### System Database

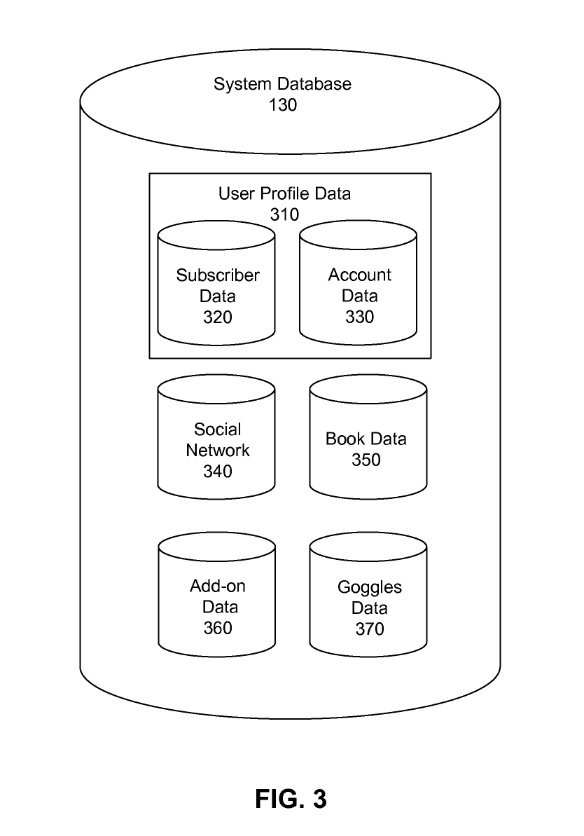

FIG. 3 illustrates a functional view of the system database 130 that stores data related to the content hosting system 110. The system database 130 may be divided based on the different types of data stored within. This data may reside in separate physical devices, or it may be collected within a single physical device. System database 130 in some embodiments also provides processing related to the data stored therein.

User profile data storage 310 includes information about an individual user, to facilitate the image search, ordering, payment and collaborative aspects of system 100. Subscriber data storage 320 includes identifying information about the user. In some embodiments this is information provided by the user manually, while in other embodiments the user is given an opportunity to agree to the collection of such information automatically, e.g., the electronic books the user has obtained and the social network groups the user has joined. In some embodiments, subscriber data storage 320 also maintains information regarding how far the user has progressed in a particular book, for instance to keep track of which portions of the book have already been unlocked for the user to read. Just as known electronic reader systems (e.g., Google Books) synchronize the user's current reading location in a book so that the user can begin reading on a mobile device while on a bus and continue reading from the correct location on a desktop machine when at home, subscriber data storage 320 keeps track of the unlocking status of the user in a book, and does so in a manner that is not solely local to one reading device. Thus, subscriber data storage 320 contains, in some embodiments, data about the user that is not explicitly entered by the user, but which is tracked as the user navigates through books and related materials.

Account data storage 330 keeps track of the user's payment mechanisms (e.g., Google Inc.'s CHECKOUT®) related to the user's ability to obtain content from system 100. Social network 340 maintains in data storage devices the information needed to implement a social network engine to provide the collaborative features discussed herein, e.g., social graphs, social network preferences and rules that together facilitate communication among readers. In practice, it may be that various distributed computing facilities implement the social networking facilities and functions described herein. For example, certain existing features of the Google+ social networking facility can implement some of the functions of social network facility 340. Social network 340 will be used here to reference any facilities to implement the social networking functions discussed herein.

Book data 350 stores the actual content that is provided to users upon their request, such as electronic book files, as well as related information as may be maintained (e.g., metadata regarding such books including for instance image search result mappings indicating which types of images will be sufficient to allow unlocking of content).

Add-on data storage 360 maintains information for related features. In some instances, this includes non-static data relating to books (e.g., usage statistics, book ratings and reviews) and in some embodiments other information (e.g., school class rosters to determine which students will be allowed to share information regarding images that can be used unlock content).

Goggles data 370 comprises information used for image searching as described above. In some embodiments, such data includes actual image files, while in other embodiments, only defining data (e.g., vector mappings) used for comparison with new images are maintained. Goggles data 370 also includes, in some embodiments, the corresponding processing facilities for providing the image search results as discussed herein. As an illustrative example, in one embodiment a user's reader module 181 submitting an image of the Eiffel Tower for processing will cause other images of the Eiffel Tower in Goggles Data 370 to be matched, and corresponding search results that are returned may include “Eiffel Tower”, “Paris” and “France”.

In various embodiments, system database 130 includes other data as well. For providers creating paid books or other content, system database 130 contains billing and revenue sharing information for the provider. Some providers may create subscription channels while others may provide single payment or free delivery of electronic books and related information. These providers may have specific agreements with the operator of the content hosting system 110 governing how revenue will flow from the content hosting system 110 to the provider. These specific agreements are contained in the system database 130.

Alternatively, some providers may not have specific agreements with the operator of the content hosting system 110 governing how revenue will flow from the content hosting service 110 to the provider. For these providers, system database 130 includes a standardized set of information dictating how revenue will flow from the content hosting system 110 to the providers. For example, for a given partner, the partner data may indicate that the content hosting system 110 receives 25% of the revenue for an item provided to a user as the result of unlocking content as described herein, and the content provider receives 75%. Of course other more complex allocations can be used with variable factors based on features, user base, and the like.

In one embodiment, conventional mechanisms are used to implement many of the aspects of system database 130. For example, the existing mechanisms from Google Inc.'s BOOKS™, GOGGLES™, GMAIL™, BUZZ™ CHAT™, TALK™, ORKUT™, CHECKOUT™, YOUTUBE™, SCHOLAR™, BLOGGER™, GOOGLE+™ and other products include aspects that can help to implement one or more of storage facilities 310, 320, 330, 340, 350, 360 and 370 as well as modules 220, 230, 240, 250, 260 and 270. Google Inc. already provides eBook readers for ANDROID™ devices (phones, tablets, etc.), iOS devices (iPhones®, iPads® and other devices from Apple, Inc.) and various desktop Web browsers, and in one embodiment Google Inc.'s EDITIONS™ and EBOOKSTORE™ eBook-related applications and facilities are modified to provide the functionality described herein.

As mentioned above, user profile data 310 is usable on a per-reader basis and is also capable of being aggregated for various populations of subscribers. The population can be the entire subscriber population, or any selected subset thereof, such as targeted subscribers based on any combination of demographic or behavioral characteristics, or content selections. System-wide usage data includes trends and patterns in usage habits for any desired population. For example, correlations can be made between electronic books and add-ons that purchasers of those books choose (presumably related in some way to those books). In one embodiment, when a user obtains a new book, such data are used to recommend other related items the user might also be interested in obtaining Valuation of items, relative rankings of items, and other synthesized information can also be obtained from such data.

### Computing Machine Architecture

FIG. 4 is a block diagram illustrating components of an example machine able to read instructions from a machine-readable medium and execute those instructions in a processor. Specifically, FIG. 4 shows a diagrammatic representation of a machine in the example form of a computer system 400 within which instructions 424 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include graphics display unit 410 (e.g., a plasma display panel (PDP), a liquid crystal display (LCD), a projector, or a cathode ray tube (CRT)). The computer system 400 may also include alphanumeric input device 412 (e.g., a keyboard), a cursor control device 414 (e.g., a mouse, a trackball, a joystick, a motion sensor, or other pointing instrument), a data store 416, a signal generation device 418 (e.g., a speaker), an audio input device 426 (e.g., a microphone) and a network interface device 420, which also are configured to communicate via the bus 408.

The data store 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network (not shown) via network interface 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### Unlocking Content Using Image Recognition

The process of reading using electronic books opens up possible user experiences that have not been available in the world of paper books. Certain incentives to read can now be created that were not previously possible. Consider, for example, an electronic book implemented like a scavenger hunt game. A reader is presented a portion of a text, and then asked to accomplish some goal (e.g., provide a picture of a cat) to get to the next stage. In one embodiment, the tasks allow users to obtain access to subsequent sections of the work. The items requested can also be integrated directly into the content of the book, whether conceptually or literally. For instance, if the book asks the reader to take a picture of a pet, subsequent chapters may be written to include the concept of a pet. In another embodiment, subsequent chapters may include the actual picture of the pet, for instance in an illustration showing a character holding a photo album that includes the picture that the user submitted. Or, using an earlier example, submission of a picture of a hammer as requested by the book may open access to a chapter that references a hammer as a tool used by one of the characters. In still other embodiments, rather than a static book the user is provided with an electronic story in the form of an interactive game, in which for instance after the user correctly submits an image of a hammer, the hammer becomes available as a tool for the user (or a character) to use in the game. Note that in this paragraph, content relating to the image appears in a subsequent portion of the work (i.e., after the image is provided).

In another application, content is provided again not as a static book, but as a “travel log” application running on a smart phone. In one specific embodiment, a user is given an incentive to take images of destinations, such as the Eiffel Tower, and when those are recognized a virtual “passport” is stamped to indicate that the user has visited that location (or the corresponding city, country, etc.). Thus, submitting an image of the Eiffel Tower causes a user's virtual passport to get a stamp indicating a visit to France, as well as the user's travel log getting an entry indicating a visit to Paris. In addition to these stamps and entries, in one embodiment the user is sent one or more offers, such as an electronic coupon for a discount at a café near the Eiffel Tower or a discount code for a Paris museum or hotel. Note that in this paragraph, content relating to the image appears in an already-unlocked portion of the work (i.e., a portion the user can access before the image is provided), but submitting the image provides additional content to the user.

Another related application generates a correspondence between a prompted image and another application that may be (but need not be) tightly integrated with the electronic book. For example, a prompt provided by an electronic book might be, “Find a crossword or Sudoku puzzle.” When the user takes a picture of, say, a Sudoku puzzle in the local newspaper, processing associates the image of that puzzle with a Sudoku application that launches on the user device 180A. In one embodiment, the application launches with the actual puzzle that was imaged, based on the Goggles facility identifying the source of the puzzle and having previously or concurrently secured rights to reproduce it on the Sudoku application for that user. In another embodiment, a Sudoku puzzle not necessarily related to the imaged puzzle is launched for the user to complete.

Still another application takes advantage of the potential of image recognition to assist in enforcing single-user limitations that may be imposed on a particular work. For example, an electronic reference book may be extremely costly to produce but may be needed by an individual only rarely. Such a book might be offered in a traditional electronic version for $20, but in a single-user version for only $5. To enforce the single-user aspect, even in applications in which the book might be read on a publicly accessible workstation, system 110 may periodically prompt the user to take a self-portrait photograph and submit it to Goggles Data 370 to ensure that the image matches one that was previously submitted by the user (for instance based on an initial set-up prompt, or taken from the user's existing books account or social network profile). Thus, the user can access the book on a smart phone, tablet, laptop or even public workstation, but may be asked to provide a new image for verification from time to time. In one embodiment, processing in connection with Goggles data 370 merely performs facial recognition and unlocks content responsive to a threshold of recognition being achieved.

A second threshold of security is usable to prevent a second user from merely aiming the device's camera at a printed photograph of the authorized user. In one specific example, the user is periodically prompted to provide a self-portrait, but with poses that may change over time. One prompt may ask for a self-portrait of the person smiling, while the next prompt may ask for a self-portrait of the person with eyes closed, or in profile. The dynamic nature of these prompts makes it less feasible for a second user to simply keep available a paper photograph of the authorized user in order to unlock the content. In such embodiments, Goggles data 370 includes image recognition processing that confirms that a submitted self-portrait is indeed of the authorized user, and is also in the pose requested by the prompt (e.g., smiling, eyes closed, or profile). Those skilled in the art will recognize that existing recognition systems are usable to create a variety of prompts, and to use these prompts to unlock a variety of material conveyed electronically (including but not limited to portions of electronic books).

Generally speaking, the embodiments discussed above permit enhancement of a user experience with electronic media by the application of image recognition using existing computing devices such as smart phones.

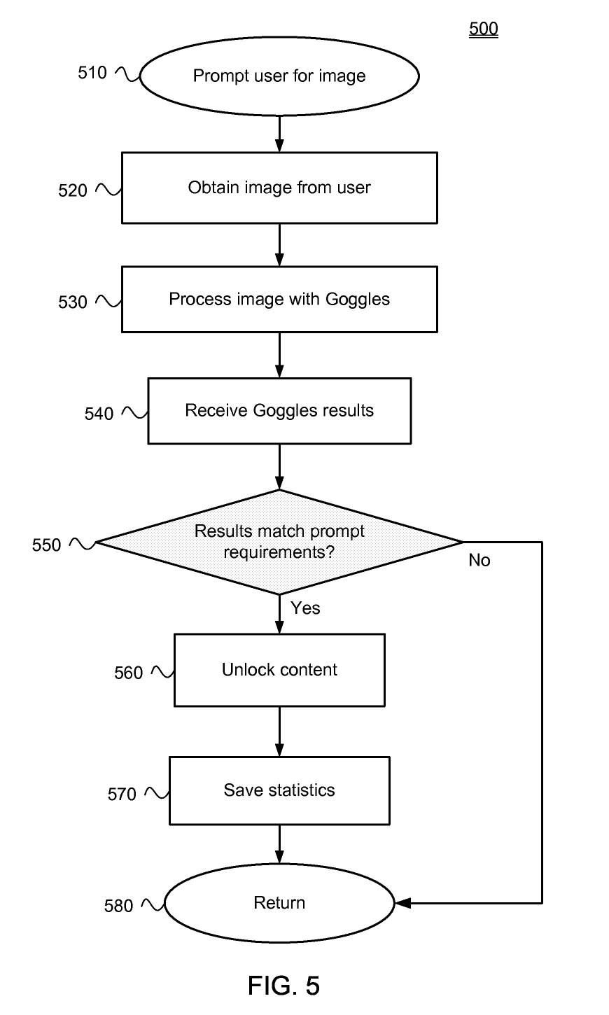

Referring now to FIG. 5, there is illustrated an exemplary method 500 of implementing an electronic book with content that can be unlocked through use of image recognition. Processing commences at step 510, in which an electronic book, as processed on a reader (e.g., reader module 181) prompts a user to provide an image. In one embodiment, the prompt is triggered by the user reaching a certain point in the electronic book (e.g., completing chapter 1) and the prompt is displayed as a pop-up user interface element with an instruction (e.g., find a red barn) and a button labeled “Take Picture” that, when pressed, uses the imaging subsystem 260 of reader module 181 to activate an integrated camera and take a picture. In some embodiments where actual photography may not be feasible, an option may be provided to the user to “virtually” find the requested item, for instance by doing an image search on the Internet and submitting a link to an image of the requested object.

The next step 520 obtains the image from the user device (e.g., 180A). In one embodiment, Goggles communication subsystem 220 is configured to send the image file from user device 180A to a centralized location for processing, e.g., Goggles data 370 of system database 130.

Then, at step 530 the image is processed by the image search facility, e.g., the Google Goggles facility. Those skilled in the art will recognize that such facilities are configured to receive as input an image and to generate information related to that image. For example, if a picture of a pickup truck is submitted, the facility may determine a correspondence between that picture and other images of pickup trucks stored in Goggles data 370. Similar images are then analyzed for relevant information, such as source information if the image came from a particular website, text terms used in that website, etc. In one embodiment, the output from such processing is a list of websites with similar pictures, for example a website for Chevrolet, a website for a utility vehicle accessories company, etc. In another embodiment, the output is a ranked list of terms from such websites with similar pictures, e.g., “pickup”, “truck”, “bedliner”, “tailgate”. Generally speaking, the results are referred to as “metadata” corresponding to the input image.

In step 540, such results are received from the Goggles facility. In one embodiment, the results are received at the Goggles data 370 portion of system database 130; in another embodiment they are received at user device 180A, based on where subsequent processing on this data is to be performed.

Then, at step 550 a check is made to see whether the results match the requirements of the prompt. For example, if the prompt was “Find a vehicle” then the check would determine whether the image results indicate a correspondence with “vehicle” (either literally or conceptually, as discussed above). If no such correspondence is determined, processing returns at step 580.

If a match is found, then the content of the electronic book for which the prompt was provided is unlocked at step 560 so that the user can access it.

At step 570, statistics regarding the search are also saved in system database 130. In one embodiment user profile data 310 is updated to indicate that the user is now authorized for the content that was just unlocked. In some embodiments, the specific statistics for the search and the comparison with the prompt are also saved in system database 130. For example, Goggles data 370 are updated to indicate correspondence between the prompt and the search results, using machine learning techniques known to those skilled in the art. Thus, performance of the Goggles facility improves with time such that a term “pickup truck” is more readily associated with the terms “vehicle”, “automobile” and “car” than may initially have been the case. Thereafter, processing returns at step 580.

### Additional Considerations

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs executed by a processor, equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for providing electronic textbooks using a content hosting system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A system to selectively unlock a portion of an electronic book, comprising:
a system database storing book data and user profile information;
a reader device in communication with the system database, the reader device configured to provide a prompt to a user to submit an image;
an image processing facility, the image processing facility configured to receive data relating to the image from the reader device, the image processing facility further configured to generate metadata corresponding to the image; and
an unlocking subsystem in communication with the image processing facility, the unlocking subsystem configured to unlock the portion of the electronic book responsive to correspondence between the prompt and the metadata.

2. The system of claim 1, wherein the portion is a chapter.

3. The system of claim 1, further comprising an ordering subsystem operatively coupled to the reader device, the ordering subsystem configured to generate a communication to the user related to the prompt.

4. The system of claim 3, wherein the communication is an electronic advertisement.

5. The system of claim 1, wherein the image is of the user.

6. The system of claim 1, wherein the portion relates to the image.

7. The system of claim 1, wherein the electronic book further comprises a prior portion, wherein the prior portion relates to the image.

8. A system to selectively unlock content for access on a device by a user, comprising:
a system database configured to store the content and to store profile information of the user;
an interface subsystem configured to provide a prompt to the user to supply an image;
an image processing facility, the image processing facility configured to receive data relating to the image from the device and generate results therefrom; and
an unlocking subsystem in communication with the image processing facility, the unlocking subsystem configured to unlock the content responsive to correspondence between the prompt and the results.

9. The system of claim 8, wherein the interface subsystem is configured to provide a subsequent prompt to the user to submit a subsequent image, the prompt and the subsequent prompt being different.

10. The system of claim 8, wherein the image is a self-portrait of the user in a first pose and the subsequent image is a self-portrait of the user in a second pose.

11. A computer-implemented method of unlocking a portion of an electronic book, comprising:
storing book data and user profile information in a database;
providing a prompt to a user to supply an image via a user device;
generating metadata corresponding to the image;
unlocking the portion of the electronic book responsive to correspondence between the prompt and the metadata; and
updating a database to indicate that the portion has been unlocked.

12. The method of claim 11, wherein the portion is a chapter.

13. The method of claim 11, further comprising providing a communication to the user related to the prompt.

14. The method of claim 11, wherein the communication is an electronic advertisement.

15. The method of claim 11, wherein the image is of the user.

16. The method of claim 11, wherein the portion relates to the image.

17. The method of claim 11, wherein the electronic book further comprises a prior portion, wherein the prior portion relates to the image.

18. A computer-implemented method for selectively unlocking content for access on a device by a user, comprising:
storing the content and profile information of the user in a system database;
providing a prompt to the user to supply an image;
processing the image and generating results therefrom; and
unlocking the content responsive to correspondence between the prompt and the results.

19. The method of claim 18, further comprising providing a subsequent prompt to the user to provide a subsequent image, the prompt and the subsequent prompt being different.

20. The method of claim 18, wherein the image is a self-portrait of the user in a first pose and the subsequent image is a self-portrait of the user in a second pose.

21. A system to selectively provide content for access on a device by a user, comprising:
a system database configured to store the content and to store profile information of the user;
an interface subsystem configured to provide a prompt to the user to supply a sensed input;
a processing facility configured to receive data relating to the sensed input from the device and generate results therefrom; and
an unlocking subsystem in communication with the processing facility, the unlocking subsystem configured to provide the content responsive to correspondence between the prompt and the results.

22. The system of claim 8, wherein the sensed input is one or more of: a static image, a moving image, a sound, an environmental condition.

23. A computer-implemented method for selectively providing content for access on a device by a user, comprising:
storing the content and profile information of the user in a system database;
providing a prompt to the user to supply a sensed input;
processing the sensed input and generating results therefrom; and
providing the content responsive to correspondence between the prompt and the results.

24. The method of claim 23, wherein the sensed input is one or more of: a static image, a moving image, a sound, an environmental condition.
